(19) United States
(12) Patent Application Publication
(10) Pub. No.: US 2005/0023939 A1
(43) Pub. Date: Feb. 3, 2005

(54) Mountable gravity-feed dispenser

(76) Inventors: Barry Kramer, Stamford, CT (US); Glenn M. Smith, New York, NY (US); Albert W. Lian, Stamford, CT (US)

Correspondence Address: KENYON & KENYON, ONE BROADWAY, NEW YORK, NY, 10004, US

(21) Appl. No.: 10/630,431

(22) Filed: Jul. 29, 2003

(51) Int. Cl. B65G 59/00

(52) U.S. Cl. 312/45; 312/138.1

(57) ABSTRACT

A gravity-feed bottle or can dispenser including a frame that is connectable to a panel, e.g., a cooler door panel, via a connector, e.g., suction cups. The frame is arranged to receive advertisement boards removably connected to front and back surfaces.

### FIELD OF THE INVENTION

The present invention relates to a mountable dispenser. More particularly, the invention relates to a can or bottle gravity-feed dispenser mountable on a surface, such as a refrigerator door.

### BACKGROUND INFORMATION

Soft drinks may be presented at a point of purchase in refrigerated cabinets in which a plurality of soft drink cans or bottles are made available for selection by a purchaser. The refrigerated cabinets may be provided with an access door having a large transparent panel through which shelved products can be viewed. Gravity-feed racks have been provided in connection with such refrigerated cabinets to maintain a supply of soft drink cans and bottles or other canned or bottled beverages available for dispensing serially at convenient dispensing locations, with the dispensed bottles being replaced by gravity-feed from the supply so that a bottle consistently is made available for display and dispensing at the dispensing location.

Gravity-feed product dispensers may stack the product containers held therein vertically. When a product is desired, the consumer pulls the product container that is in the withdrawal position at the bottom of the vertical stack, horizontally towards him or herself until that container is completely freed from the stack. After the product container in the withdrawal position is freed from the stack, the product container that was immediately above the freed container, i.e., the penultimate container, falls downwardly into the withdrawal position due to gravity. Likewise, the remaining product containers in the stack each fall downwardly one position.

Among the more common racks available for the display and serial dispensing, by gravity, of bottled or canned soft drinks are those which include trays for supporting a row of bottles with the bottoms of the bottles resting within a chute inclined toward the dispensing location. While such chutes may be attractive and effective in presenting bottles for ready selection, they do not take advantage of an unused dead space, extending from top-to-bottom and side-to-side of the transparent door panel, between the inside surface of the door panel and the conventional shelf elements of the refrigerated cabinet.

Existing door mounted shelves, which do take advantage of the dead space, have not been entirely satisfactory for additional product storage and display because of problems relating to capacity, access to products on the shelf, and retention, especially given the pivoting dynamic nature of the door.

While the conventional beverage dispenser and storage units may be suitable for the particular purpose employed, or for general use, they are not as suitable for the purposes of the present invention as disclosed hereafter.

Accordingly, it is an aspect of the present invention to provide a refrigerated cabinet door panel mountable gravity-feed bottle and/or can dispenser that fits in the dead space between the inside surface of the door panel and the conventional shelf elements of the refrigerated cabinet.

### SUMMARY

An example embodiment of the present invention includes a gravity-feed bottle and/or can dispenser having a frame that is connectable to a cooler door panel, for example a transparent panel, via suction cups. The frame includes spaced apart opposing back and front walls and spaced apart opposing side walls which together define a channel for receiving a vertical stack of product containers, including but not limited to beverage cans and bottles. The back and front walls span the side walls along at least a portion of the length of the side walls. A bottom wall, including a curved retainer portion also projects from the back wall and is used to support the stacked column of bottles, cans, other items, etc. in the channel. The back wall optionally includes a cut-out so as to render at least one bottle, can, other item etc. in the channel visible through the transparent cooler door to which the dispenser is removably connected.

A visual display, such as an advertisement board, is removably connected via retainers, such as but not limited to brackets, to the front and back sides of the dispenser. When the dispenser is connected to the cooler door the visual display on the back side is between the cooler door and the dispenser and is visible to a customer in a store through the cooler door. The bottom product container is also visible through the cut-out in the back wall. The visual display on the front side of the dispenser is visible when the cooler door is opened.

The bottom of the front wall is spaced from the bottom wall a distance equal to approximately the height of one product container so as to have only the bottom product container in the stack exposed, i.e., outside the channel defined by the walls, and ready for dispensing. The curved retainer portion applies a lateral retaining force towards the back wall holding the bottom product container in place on the bottom wall. The bottom product container may be removed from the dispenser by pulling it up over the retainer and away from the dispenser. Upon removal of the bottom product container gravity forces the entire column of product containers downward and the penultimate product container becomes the bottom item and rests on the bottom wall ready for removal.

In an exemplary embodiment of the present invention the item dispenser includes a pair of spatially separated side walls, a connector arranged on a first side of the dispenser configured to mount the dispenser to a surface, a first barrier extending along at least a partial length of and spanning the side walls to form a channel between the side walls and the first barrier, a bottom wall configured to support items arranged in the channel, and a first visual display. The first visual display may be arranged on the dispenser such that it is between the surface and the dispenser when the dispenser is mounted on the surface.

The dispenser may include at least one of a first retainer configured to receive the first visual display between the dispenser and the surface and a second retainer configured to receive a second visual display on a second side of the dispenser opposite the first side of the dispenser.

The pair of spaced apart side walls may each have a front edge and a back edge and the first barrier may extend along at least a partial length of and span the side walls adjacent the front edge of each side wall. Further, the back edge may be adjacent the surface when the dispenser is mounted on the surface.

The second barrier may span the side walls adjacent the back edge of the side walls. The side walls, first barrier and second barrier may form the channel for storage and passage of items in the dispenser.

The second barrier may be detachably attachable to the dispenser.

The second barrier may include an extension which may fit into a recess in the second side of the dispenser and may support the second barrier on the dispenser.

A second visual display may be arranged on a second side of the item dispenser opposite the first side.

The first retainer may include a first recess and the second retainer may include a second recess.

The first visual display may be at least partially disposed in the first recess.

The item retainer portion may be one of adjacent to and extending from the bottom wall and configured to apply a force in a direction away from the first barrier and towards the first side of the dispenser on an item supported by the bottom wall.

The first visual display may include a flat board.

The second visual display may include a flat board.

The first retainer and second retainer may include a bracket.

The second barrier may extend along the side walls from a third position adjacent a top of the side walls to a fourth position above the bottom wall between the top and a bottom of the side walls.

The connector may include at least one suction cup.

The first barrier may extend along the side walls from a first point to a second point above the bottom wall between a top and bottom of the side walls. The first point may be closer to the top of the side walls than the second point. The dispenser may be configured to receive, store and dispense items from a predetermined orientation from the channel, each item having a predefined width between the side walls and a predefined height along a length of the side walls. The distance between the bottom wall and the second position of the first barrier may be between approximately one and one and a half times the height of the item. The distance between side walls may be greater than the width of one item.

The distance between the bottom wall and the fourth position of the second barrier may be between approximately one and two times the height of one item.

The item dispenser may include a pair of spaced apart side walls each having front and back edges, a bottom wall, a connector on a back side of the dispenser configured to removably mount the dispenser to a surface, a front barrier extending along at least a partial length of and spanning the side walls adjacent the front edges, and a front retainer configured to retain a front visual display and connected to at least one of the front barrier and the front edges of the side walls.

The front visual display may be supported by and at least partially disposed within the front retainer.

The connector may include at least one suction cup and the front visual display may include a flat board having indicia on at least one surface.

The item dispenser may include a pair of side walls spaced a distance apart and extending from a top point to a bottom point. The side walls may each have a front edge and a back edge. A back wall may span the side walls and have a cut-out between the side walls. The cut-out may extend from a point adjacent the bottom point to a first point in between the top point and the bottom point. The side walls may project from a front surface of the back wall. The back edge of each side wall may be connected to the back wall. Further, a front wall may span the side walls and extends from a point adjacent the top point to a second point in between the top point and the bottom point. The front edge of each side wall may be connected to the front wall. Further, a bottom wall connected between the side walls adjacent the bottom point may be configured to support items in the item dispenser and apply a retaining force to a supported item in the direction of the back wall. Further, at least one suction cup may be configured to connect the dispenser to a surface.

The back wall may include a lip around at least a portion of its periphery.

The item dispenser may further include a retainer connected to a back surface of the back wall. The retainer may removably secure a flat board to the back wall.

The item dispenser may further comprise a retainer connected to the front wall. The retainer may removably secure a flat board to the front wall.

The cut-out may have a height along a length of the side walls that is at least equal to the height of one item.

Another exemplary embodiment of the present invention is a method for storing and displaying items including the steps of connecting a frame to a surface of a transparent panel and at least partially filling the channel with items vertically stacked. The dispenser may include a pair of spatially separated side walls, a connector arranged on a first side of the dispenser configured to mount the dispenser to the inner surface, a first barrier extending along at least a partial length of and spanning the side walls to form a channel between the side walls and the first barrier, a bottom wall configured to support items arranged in the channel, and a first visual display arranged on the dispenser such that it is between the surface and the dispenser when the dispenser is mounted on the surface.

The second barrier may include a second barrier cut-out.

In an area of the second barrier cut-out the channel may be at least partially defined by the transparent panel and at least one item contained in the channel may be visible through the second barrier cut-out and the transparent panel.

The item dispenser may have at least one of a first retainer configured to receive the first visual display between the dispenser and the surface and a second retainer configured to receive a second visual display on a second side of the dispenser opposite the first side of the dispenser. Further, the method may include the step of at least partially sliding the first visual display into one of the first retainer and the second retainer.

The first visual display may include a board having indicia on at least one surface.

A height of the cut-out along the side walls may be less than approximately the height of two items.

The item dispenser may include a pair of spaced apart side walls each having a top, bottom, front edge and back edge, a bottom support means, a connector means on a back side of the dispenser for removably mounting the dispenser to a surface, a front barrier means spanning the sidewalls adjacent the front edges of the side walls, and a back visual display means connected on the back side of the dispenser such that when the dispenser is mounted on the surface the back visual display means is between the dispenser and the surface and is visible through the surface. The front barrier may extend along the side walls from a first point to a second point above the bottom support means between the top and bottom of the side walls. The first point may be closer to a top of the side walls than the second point. The side walls and front barrier means may form a channel for storage, passage and display of items in the dispenser. The bottom support means may support items in the channel and removably retain a bottom item.

An intermediary wall may divide the channel into at least two channels.

The surface may be a surface of a transparent cooler door having an opened position and a closed position. The first visual display may visible through the cooler door when the cooler door is in the closed position and the second visual display may be visible when the cooler door is in the open position.

Example embodiments of the present invention may be embodied in the form illustrated in the accompanying drawings. Attention is called to the fact, however, that the drawings are illustrative only. Variations are contemplated as being part of the present invention, limited only by the scope of the appended claims.

### BRIEF DESCRIPTION OF THE DRAWINGS

In the drawings, like elements are depicted by like reference numerals. The drawings are briefly described as follows.

FIG. 1 is a perspective view of a cooler with an example embodiment of a gravity-feed dispenser mounted on an inner surface of a transparent panel of the door.

FIG. 2 is a perspective view of the cooler as shown in FIG. 1 with the door open.

FIG. 3 is a plan view of the example embodiment of the dispenser of the present invention, as facing the cooler shelves and seen by a customer when the cooler door is open, shown in an empty state and without advertisement boards.

FIG. 4 is a side view of the example embodiment of the dispenser and partial side views of advertisement boards positioned over their respective front and rear retainers.

FIG. 4A is a transverse cross-sectional view of the dispenser taken along line 4A-4A in FIG. 4.

FIG. 5 is a plan view of the example embodiment of the dispenser, opposite that shown in FIG. 3, as seen by a customer when the cooler door is closed.

FIG. 6 is a perspective view of the example embodiment of the dispenser with an advertisement board supported in the store-side retainer.

FIG. 7 is a perspective view of the example embodiment of the dispenser of FIG. 6 without the advertisement board supported in the store-side retainer.

FIG. 8 is a perspective view of an example embodiment of the dispenser with the store-side panel completely removed, exposing a vertical stack of cans and a recess.

FIG. 9 is a perspective view of the dispenser of FIG. 8 shown without the vertical stack of cans.

FIG. 10 is a perspective view of the example embodiment of the dispenser of FIGS. 8 and 9 shown with the store-side panel exploded off the glass-facing wall.

### DETAILED DESCRIPTION

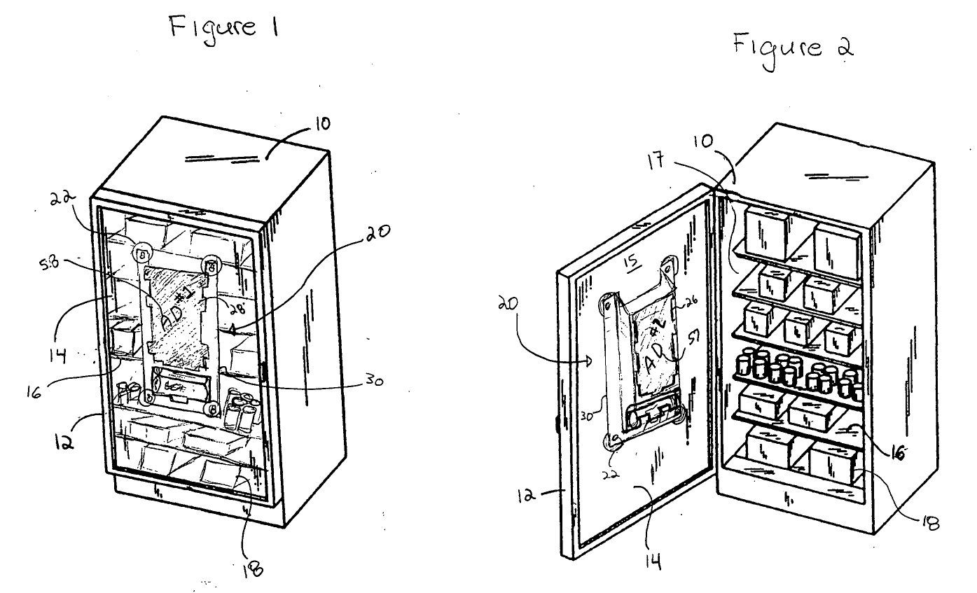

FIG. 1 illustrates a closed refrigerated cabinet or cooler 10 for cool storage and display of items 18. Cooler 10 includes a door 12, including a transparent door panel 14, and shelves 16. The dispenser of the present invention, designated generally as 20 and visible through transparent door panel 14, is removably connected to an inner surface 15 of door panel 14 via connectors 22, e.g., suction cups.

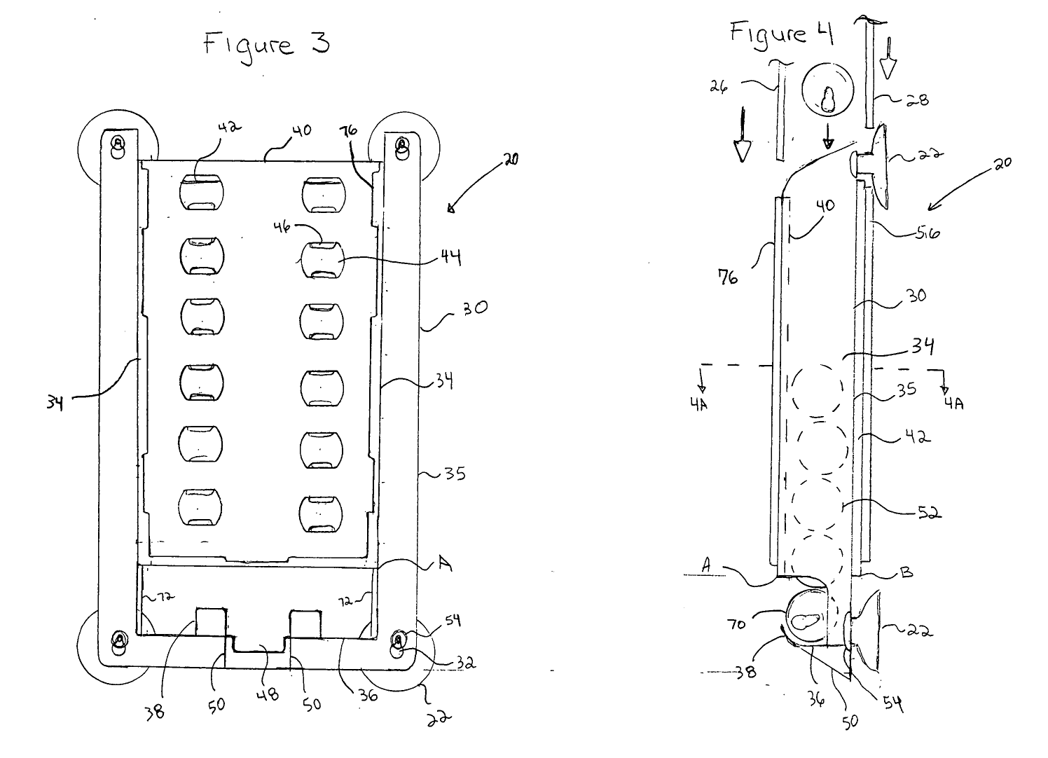

FIG. 2 illustrates cooler 10 with door 12 in an opened state directly revealing dispenser 20 mounted on inner surface 15. Dispenser 20 may occupy a dead space 17 between inner surface 15 and shelves 16 when door 12 is closed.

FIG. 3 is a plan view of dispenser 20 as seen by a customer when the cooler door 12 is open. Dispenser 20, shown in an empty state and without advertisement boards for clarity, includes a frame 30 removably connectable, via suction cups 22 to a surface, such as inner surface 15 of door panel 14. Alternatively, frame 30 may be connected to surface 15 via other connectors, such as, but not limited to, adhesive, double-sided adhesive tape, velcro, hooks, screws, bolts, etc.

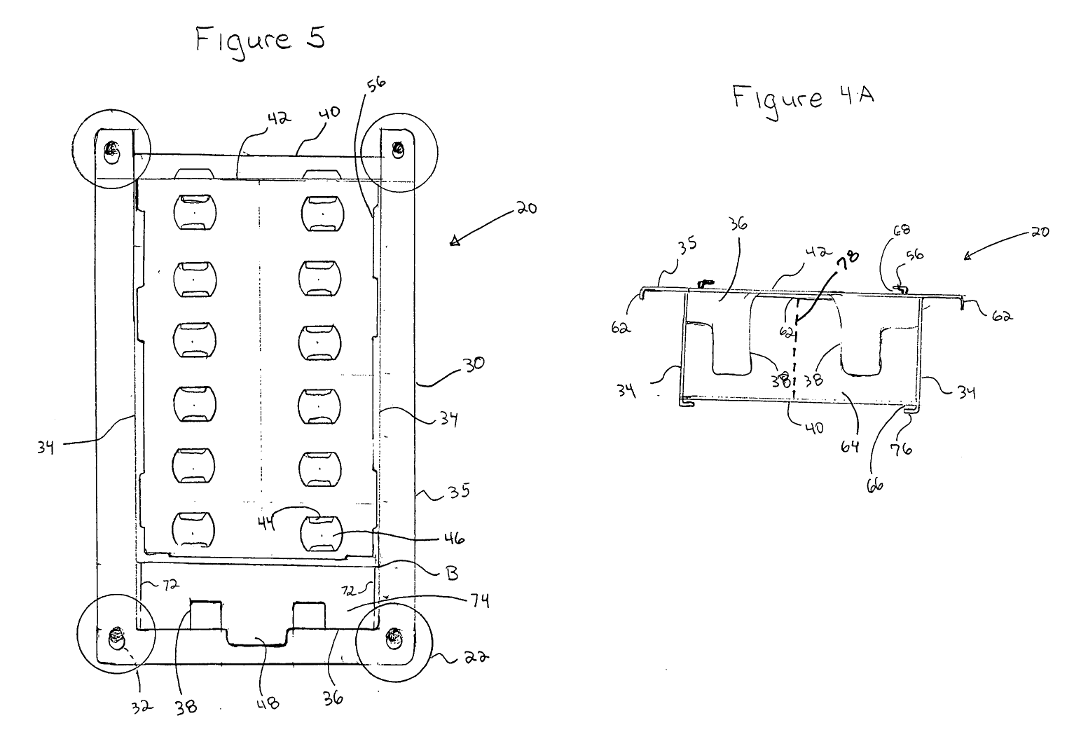

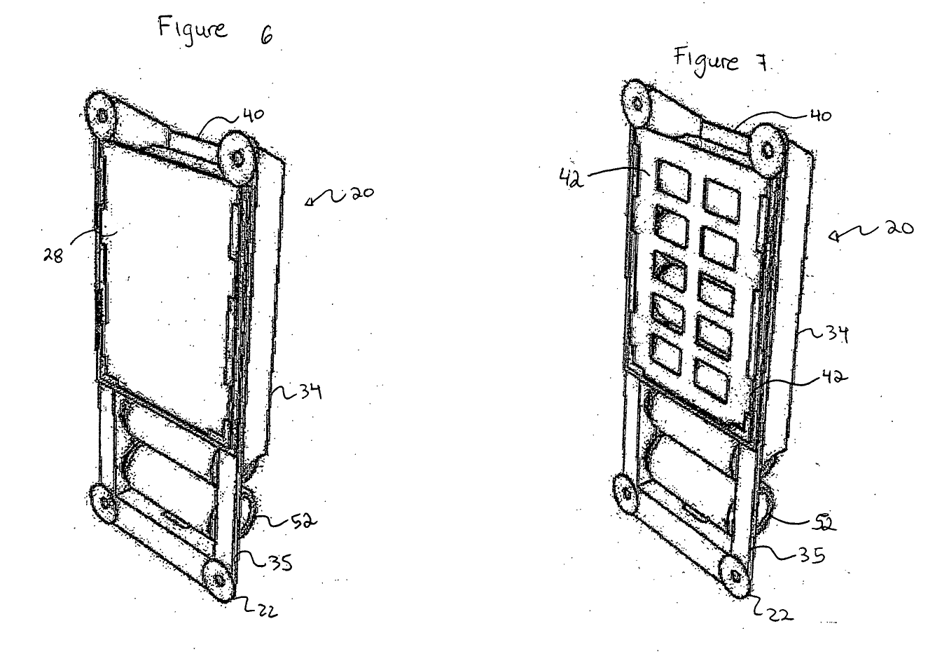

Frame 30 includes a glass-facing wall 35, a barrier 40, a barrier 42, a bottom wall 36 and a pair of side walls 34. The barrier 40 may correspond to a cooler-side panel 40, and barrier 42 may correspond to a store-side panel 42. As best seen in the side view of FIG. 4, bottom wall 36 and side walls 34 project, e.g., at right angles, from glass-facing wall 35. Glass-facing wall 35 includes holes 32 for securing suction cups 22 via retainer hubs 54. Furthermore, glass-facing wall 35 includes a lip 62 (shown only in FIG. 4A for clarity) along its periphery, which enhances the stiffness of glass-facing wall 35. Bottom wall 36 supports a vertical column of cans 52, shown only in FIG. 4 for clarity, and is buttressed by triangular supports 50. Cans 52 are shown completely in ghost lines, except for a portion of a bottom can 70, as they are contained between side walls 34. Curved retainer portions 38 project from bottom wall 36 and apply a lateral retaining force on bottom can 70 towards glass-facing wall 35. Bottom wall 36 includes a finger cut-out 48 for facilitating removal of bottom can 70 from the dispenser 20

As an alternative to curved retainer portions 38 or in addition to curved retainer portions 38 a spring loaded retainer flap, door, etc. may be connected to a bottom edge of cooler-side panel 40. The door provides a sufficient lateral force against bottom can 70 when in a closed position to maintain the vertical stack of cans 52 in dispenser 20. Opening the door by pulling a bottom portion of it away from the dispenser allows for access to bottom can 70 in the stacked pile.

Cooler-side panel 40 includes a bracket or board retainer 76 affixed to cooler-side panel 40 for holding a visual display, such as a cooler-side advertisement board 26. Similarly, store-side panel 42 includes a bracket or board retainer 56 for holding a visual display, such as a store-side advertisement board 28. The visual display may also include a flat screen television. As shown in FIG. 4, boards 26 and 28 are slid in the direction of the arrows into respective board retainers 76 and 56 on both sides of dispenser 20. When in place, board 26 rests in a recess 66 defined by panel 40 and retainer 76 (seen in FIG. 4A) and board 28 rests in a recess 68 (seen in FIG. 4) defined by panel 42 and retainer 56. Board 26 may include information or advertisement indicia 57, as seen in FIG. 2, and board 28 may include information or advertisement indicia 58, as seen through transparent panel 14 in FIG. 1. Alternatively, the visual display may be painted or, if in the form of a sticker or poster, pasted or otherwise adhered directly on either cooler-side panel 40 or store-side panel 42.

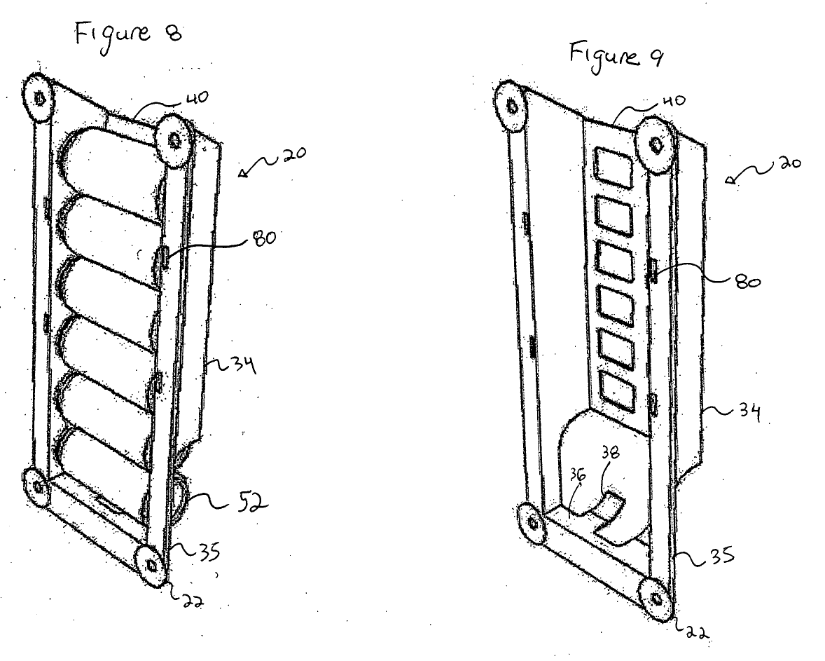

FIG. 6 is a perspective view of the dispenser 20 holding cans 52 with board 28 supported in retainer 56. FIG. 7 is a perspective view of dispenser 20 holding cans 52 without board 28 supported in retainer 56.

FIG. 4A is a transverse cross-sectional view of dispenser 20 taken along lines 4A-4A in FIG. 4. For clarity dispenser 20 is shown without cans 52. Glass-facing wall 35, cooler-side panel 40, store-side panel 42 and side walls 34 define a channel 64 in which product containers are stored and through which product containers are forced by gravity to pass, upon removal of a product container from the bottom of the stack, until they finally reach curved retainer portions 38.

A connector, such as retainers 76 and 56, which may allow for quick and easy change of visual displays may be provided. However, board 26 may be connected to cooler-side panel 40 and board 28 may be connected to store-side panel 42 by other connection device, such as tape, snaps, hooks, adhesive, velcro, etc. Furthermore, a visual display may be used on only one side of dispenser 20 or eliminated all together. The visual display itself may function as a front and/or a back wall, in which case the cooler-side panel 40 and/or the store-side panel 42 may be eliminated.

Cooler-side panel 40 includes holes 44 and store-side panel 42 includes holes 46. With at least one of boards 26 and 28 removed, holes 44 and 46 facilitate an inventory inspection of product containers in dispenser 20. Furthermore, by eliminating material holes 44 and 46 make the dispenser 20 lighter. Cooler-side panel 40, store-side panel 42, side walls 34 and bottom wall 36 may be replaced with any product container retaining structure or barrier including but not limited to a different panel configuration, a mesh, etc. The number and shape of holes 44 and 46 may vary.

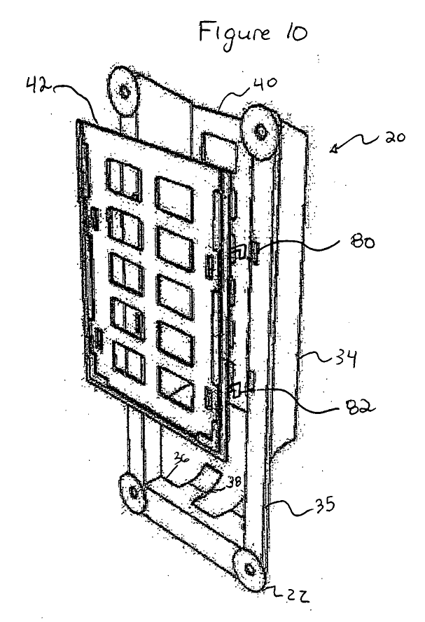

In an example embodiment, store-side panel 42 may optionally be eliminated as door panel 14 itself may be arranged as a retaining panel when dispenser 20 is mounted on surface 15. In another example embodiment of dispenser 20, illustrated in FIGS. 8 to 10, store-side panel 42 may be removably connected to glass-facing wall 35 via connectors such as a hook and loop fastener, L-shaped extensions, hooks, etc. As illustrated in FIG. 10, the connectors correspond to L-shaped extensions 82, which project from store-side panel 42 and fit in recesses 80 in glass-facing wall 35. FIG. 8 is a perspective view of the dispenser 20 with the store-side panel 42 completely removed, exposing the vertical stack of cans 52 and recess 80. FIG. 9 is a perspective view of the dispenser of FIG. 8 shown without the vertical stack of cans 52. FIG. 10 is a perspective view of the dispenser 20 of FIGS. 8 and 9, but shown with the store-side panel 42 exploded off glass-facing wall 35. Store-side panel 42 may be removed from dispenser 20 by shifting store-side panel 42 upwardly relative to dispenser 20, disengaging the L-shaped extension 82, and then away from the dispenser 20.

As seen in FIG. 3, cooler-side panel 40 extends down to a point A providing sufficient space between the bottom of cooler-side panel 40 and bottom wall 36 for bottom can 70 to be pulled out over curved retainer portions 38 and away from the dispenser 20. As seen in FIG. 5, store-side panel 42 extends down to a point B providing a customer an unobstructed view through door panel 14 of at least bottom can 70 in the stack. In the area below store-side panel 42 glass-facing wall 35 may optionally have retainer extensions 72 (see FIGS. 3 and 5), so as to prevent cans from falling out through back wall cut-out 74 when dispenser 20 is detached from surface 15.

Dispenser 20 may be injection molded, cast, etc. as a single unit. Alternatively, each element, including glass-facing wall 35, cooler-side panel 40, store-side panel 42, bottom wall 36, supports 50, retainers 76 and 56, curved retainer portions 38 and side walls 34 maybe separately produced and individually connected to each other. Dispenser may be made from a light weight durable plastic material strong enough to contain a column of beverage cans, bottles, or other items, for example, but light enough to minimize detachment of suction cups 22 from surface 15 of door panel 14. As illustrated, dispenser 20 accommodates a single column of cans, bottles or other items. Given the dimensions of cooler 10, this width allows a customer to see items on shelves 16 on either side of dispenser 20. Dispenser 20 may, however, be widened to accommodate two or more columns of cans, bottles, other items, etc. in which case intermediary wall(s) 78 may be used to separate the two or more columns.

As many apparently widely different embodiments of the present invention may be made without departing from the spirit and scope thereof, it is to be understood that the present invention is not limited to the specific embodiments thereof except as defined in the appended claims.

1. An item dispenser, comprising:
a pair of spatially separated side walls;
a connector arranged on a first side of the dispenser configured to mount the dispenser to a surface;
a first barrier extending along at least a partial length of and spanning the side walls to form a channel between the side walls and the first barrier;
a bottom wall configured to support items arranged in the channel; and
a first visual display arranged on the first side of the dispenser.

2. The item dispenser as claimed in claim 1, further comprising at least one of a first retainer configured to receive the first visual display between the dispenser and the surface and a second retainer configured to receive a second visual display on a second side of the dispenser opposite the first side of the dispenser.

3. The item dispenser as claimed in claim 1, wherein the pair of spaced apart side walls each have a front edge and a back edge, the first barrier extending along at least a partial length of and spanning the side walls adjacent the front edge of each side wall, said back edge adjacent the surface when the dispenser is mounted on the surface.

4. The item dispenser as claimed in claim 3, further comprising a second barrier spanning the side walls adjacent the back edge of the side walls, said side walls, first barrier and second barrier forming the channel for storage and passage of items in the dispenser.

5. The item dispenser as claimed in claim 1, further comprising a second visual display arranged on a second side of the item dispenser opposite the first side.

6. The item dispenser as claimed in claim 2, wherein the first retainer includes a first recess and the second retainer includes a second recess.

7. The item dispenser as claimed in claim 6, wherein the first visual display is at least partially disposed in the first recess.

8. The item dispenser as claimed in claim 1, further comprising an item retainer portion one of adjacent to and extending from the bottom wall and configured to apply a force in a direction away from the first barrier and towards the first side of the dispenser on an item supported by the bottom wall.

9. The item dispenser as claimed in claim 1, wherein the first visual display includes a flat board.

10. The item dispenser as claimed in claim 5, wherein the second visual display includes a flat board.

11. The item dispenser as claimed in claim 2, wherein at least one of the first retainer and second retainer includes a bracket.

12. The item dispenser as claimed in claim 4, wherein the second barrier extends along the side walls from a third position adjacent a top of the side walls to a fourth position above the bottom wall between the top and a bottom of the side walls.

13. The item dispenser as claimed in claim 1, wherein the connector includes at least one suction cup.

14. The item dispenser as claimed in claim 1, wherein the first barrier extends along the side walls from a first point to a second point above the bottom wall between a top and bottom of the side walls, said first point closer to the top of the side walls than the second point; and
wherein the dispenser is configured to receive, store and dispense items from a predetermined orientation from the channel, each item having a predefined width between the side walls and a predefined height along a length of the side walls, a distance between the bottom wall and the second position of the first barrier is between approximately one and one and a half times the height of the item, a distance between side walls is greater than the width of one item.

15. The item dispenser as claimed in claim 12, wherein the dispenser is configured to receive, store and dispense items from a predetermined orientation from the channel, each item having a predefined width between the side walls and a predefined height along a length of the side walls, a distance between the bottom wall and the fourth position of the second barrier being between approximately one and two times the height of one item.

16. An item dispenser, comprising:
a pair of spaced apart side walls each having front and back edges;
a bottom wall;
a connector on a back side of the dispenser configured to removably mount the dispenser to a surface;
a front barrier extending along at least a partial length of and spanning the side walls adjacent the front edges; and
a front retainer configured to retain a front visual display and connected to at least one of the front barrier and the front edges of the side walls.

17. The item dispenser as claimed in claim 16, further comprising a front visual display supported by and at least partially disposed within the front retainer.

18. The item dispenser as claimed in claim 17, wherein the connector includes at least one suction cup, and the front visual display includes a flat board having indicia on at least one surface.

19. The item dispenser as claimed in claim 16, wherein the front barrier extends along the side walls to a first position above the bottom wall; and
wherein the dispenser is configured to receive, store and dispense items from a predetermined orientation from the channel, each item having a predefined width between the side walls and a predefined height along a length of the side walls, the distance between the bottom wall and the second point along the front barrier being between approximately one and one and a half times the height of one item.

20. An item dispenser, comprising:
a pair of side walls spaced a distance apart and extending from a top point to a bottom point, each side wall having a front edge and a back edge;
a back wall spanning the side walls and having a cut-out between the side walls, said cut-out extending from a point adjacent the bottom point to a first point in between the top point and the bottom point, the side walls projecting from a front surface of the back wall, the back edge of each side wall connected to the back wall;
a front wall spanning the side walls and extending from a point adjacent the top point to a second point in between the top point and the bottom point, the front edge of each side wall connected to the front wall;
a bottom wall connected between the side walls adjacent the bottom point configured to support items in the item dispenser and apply a retaining force to a supported item in the direction of the back wall; and
at least one suction cup configured to connect the dispenser to a surface.

21. The item dispenser as claimed in claim 20, wherein at least a portion of a periphery of the back wall includes a lip.

22. The item dispenser as claimed in claim 20, further comprising a retainer connected to a back surface of the back wall configured to removably secure a flat board to the back wall.

23. The item dispenser as claimed in claim 20, further comprising a retainer connected to the front wall configured to removably secure a flat board to the front wall.

24. The item dispenser as claimed in claim 20, wherein the dispenser is configured to receive, store and dispense items from a predetermined orientation from the channel, each item having a predefined width between the side walls and a predefined height along a length of the side walls, a distance between the bottom wall and the second point along the front wall being approximately between one and one and a half times the height of the item, the cut-out having a height along a length of the side walls that is at least equal to the height of one item.

25. A method for storing, displaying and dispensing items, comprising the steps of:
(a) connecting a frame to a surface of a transparent panel, said frame including:
a pair of spatially separated side walls;
a connector arranged on a first side of the dispenser configured to mount the dispenser to the surface;
a first barrier extending along at least a partial length of and spanning the side walls to form a channel between the side walls and the first barrier;
a bottom wall configured to support items arranged in the channel; and
a first visual display arranged on the dispenser such that it is between the surface and the dispenser when the dispenser is mounted on the surface; and
(b) at least partially filling the channel with items vertically stacked.

26. The method as claimed in claim 25, wherein the frame includes a second barrier extending along at least a partial length of and spanning the side walls, said second barrier adjacent the surface when the dispenser is mounted on the surface, said first barrier, second barrier and side walls forming the channel.

27. The method as claimed in claim 25, wherein the second barrier includes a second barrier cut-out.

28. The method as claimed in claim 27, wherein in an area of the second barrier cut-out the channel is at least partially defined by the transparent panel and at least one item contained in the channel is visible through the second barrier cut-out and the transparent panel.

29. The method as claimed in claim 25, wherein the dispenser has at least one of a first retainer configured to receive the first visual display between the dispenser and the surface and a second retainer configured to receive a second visual display on a second side of the dispenser opposite the first side of the dispenser; and
wherein the method further comprises at least one of the steps of at least partially sliding the first visual display into the first retainer and at least partially sliding the second visual display into the second retainer.

30. The method as claimed in claim 25, wherein the first visual display includes a board having indicia on at least one surface.

31. The method as claimed in claim 25, wherein the dispenser is configured to receive, store and dispense items from a predetermined orientation from the channel, each item having a predefined width between the side walls and a predefined height along a length of the side walls; and
wherein a distance between a bottom end of the first barrier and the bottom wall is approximately equal to the height of one item.

32. The method as claimed in claim 28, wherein the items have a predefined height along the side walls and wherein a height of the cut-out along the side walls is less than approximately the height of two items.

33. An item dispenser, comprising:
a pair of spaced apart side walls each having a top, bottom, front edge and back edge;
bottom support means;
connector means on a back side of the dispenser for removably mounting the dispenser to a surface;
front barrier means spanning the sidewalls adjacent the front edges of the side walls, said front barrier means extending along the side walls from a first point to a second point above the bottom support means between the top and bottom of the side walls, said first point closer to a top of the side walls than the second point; and
back visual display means connected on the back side of the dispenser;
wherein said side walls and front barrier means form a channel for storage and passage of items in the dispenser, said bottom support means for supporting items in the channel and removably retaining a bottom item.

34. The item dispenser as claimed in claim 1, further including an intermediary wall dividing the channel into at least two channels.

35. The item dispenser as claimed in claim 16, further including an intermediary wall dividing the channel into at least two channels.

36. The item dispenser as claimed in claim 5, wherein the surface is a surface of a transparent cooler door having an opened position and a closed position, the first visual display being visible through the cooler door when the cooler door is in the closed position and the second visual display being visible when the cooler door is in the open position.

37. An item dispenser, comprising:
a pair of spatially separated side walls;
a connector arranged on a first side of the dispenser configured to mount the dispenser to a surface;
a first barrier extending along at least a partial length of and spanning the side walls to form a channel between the side walls and the first barrier;
a bottom wall configured to support items arranged in the channel; and
a visual display arranged on one of the first side of the dispenser and a second side opposite the first side.

38. An item dispenser, comprising:
a pair of spatially separated side walls;
a connector arranged on a first side of the dispenser configured to mount the dispenser to a surface;
a bottom wall configured to support items arranged in the channel; and
a visual display arranged opposite the first side of the item dispenser and extending along at least a partial length of and spanning the side walls.

39. The item dispenser as claimed in claim 38, further including a second visual display on the first side of the item dispenser extending along at least a partial length of and spanning the side walls.

40. The item dispenser as claimed in claim 4, wherein the second barrier is detachably attachable to the side walls.

41. The item dispenser as claimed in claim 40, wherein the second barrier includes an extension which fits into a recess in the second side of the dispenser and supports the second barrier on the dispenser.
